(19) United States
(12) Patent Application Publication
(10) Pub. No.: US 2007/0124906 A1
(43) Pub. Date: Jun. 7, 2007

(54) System for method of disassembling end-of-life vehicles

(76) Inventor: Cheol Min Jin, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/497,934

(22) Filed: Aug. 1, 2006

(30) Foreign Application Priority Data
Dec. 7, 2005 (KR) 10-2005-0118502

(51) Int. Cl. B07B 13/00

(52) U.S. Cl. 29/403.1; 29/403.3; 52/127.1

(57) ABSTRACT

A disassembling process of end-of-life vehicles (ELVS) takes place in a circular two-story structure. An elevator moves a vehicle between stories of the structure, and a conveyor system moves the vehicle between facilities in each story. The first and last steps in the disassembling process take place on the first story and the other steps take place in facilities arranged sequentially around the perimeter of the second story.

### CROSS-REFERENCE TO RELATED APPLICATIONS

This application claims the benefit of Korean Patent Application No. 10-2005-0118502, filed on Dec. 7, 2005, in the Korean Intellectual Property Office, the disclosure of which is incorporated herein by reference.

### BACKGROUND OF THE INVENTION

1. Field of the Invention

The present invention relates to a system for and method of disassembling end-of-life vehicles (ELVs), and more particularly to a disassembling process that takes place in a multi-story structure.

2. Background of the Related Art

The number of end-of-life vehicles (ELVs) is increasing along with the rapid increase in the number of registered cars.

An ELV is a complicated product consisting of various component parts. Pretreatment for reuse of these components is necessary. Such pretreatment traditionally uses manual operation, which is costly.

About 75% of the total weight of an ELV is iron and non-ferrous metal, which is recycled. The remaining 25% of the total weight is automobile shredder residue, which is disposed of through landfill. In general, treating an ELV is divided into two steps: recovery of secondhand components, and the shredder treatment.

Traditional disassembling systems include a cell separation-type disassembling system, in which end-of-life vehicles are treated using various facilities arranged in a planar-opened manner, and a linear serial-type disassembling system, in which ELVs are disassembled through manual operation or with semi-automatic equipment at stations arranged on a linear rail. Both the cell separation-type and the linear serial-type disassembling systems require large installation spaces and large numbers of workers.

### SUMMARY OF THE INVENTION

Embodiments of the present invention provide a system for and method of disassembling end-of-life vehicles (ELVs) in which each step of the disassembling process takes place in a multi-story structure. More than 80% of the process is automated, thereby shortening the time spent disassembling component parts and reducing the cost of disassembling per vehicle, and reducing the risk of accidents. Storage tanks outside the structure are provided to deposit component parts generated during disassembly.

Embodiments of the present invention provide a system for disassembling ELVs in which facilities are arranged in a multi-story structure such that the entire disassembling process takes place within the structure. A vehicle loading elevator provides the vertical movement of the vehicle between stories of the structure, and a conveyor system provides the movement of the vehicle between stages in each story.

In some embodiments, the facilities are arranged in the following order: a vehicle's entering the structure (stage zero), recovery of liquid products (stage one), recovery of explosive and re-usable components (stage two), recovery of interior/exterior components (stage three), recovery of engine/discharge system/chassis components (stage four), and crushing of the vehicle body (stage five).

In some embodiments, the building has two circular stories. Stages zero and five may take place in the lower story, and stages one through four may take place in the upper story. Facilities for stages 1-4 may be disposed sequentially around the circumference of the upper story.

Embodiments of the present invention provide a method of disassembling ELVs wherein facilities are arranged in a multi-story structure. The entire disassembling process may include the following stages: a vehicle's entering the structure (stage zero), recovery of liquid products (stage one), elimination of explosive components and recovery of re-usable components (stage two), recovery of interior/exterior components (stage three), recovery of engine/discharge system/chassis components (stage four), and crushing of a vehicle body (stage five). Stages zero and five may take place in a lower story, and stages one through four may take place in an upper story.

### BRIEF DESCRIPTION OF THE DRAWING

The above and other objects, features and advantages of the present invention will be apparent from the following detailed description of the preferred embodiments of the invention in conjunction with the accompanying drawing, in which:

FIG. 1 is a schematic diagrammatic view illustrating an end-of-life vehicle (ELV) disassembling system according to the present invention.

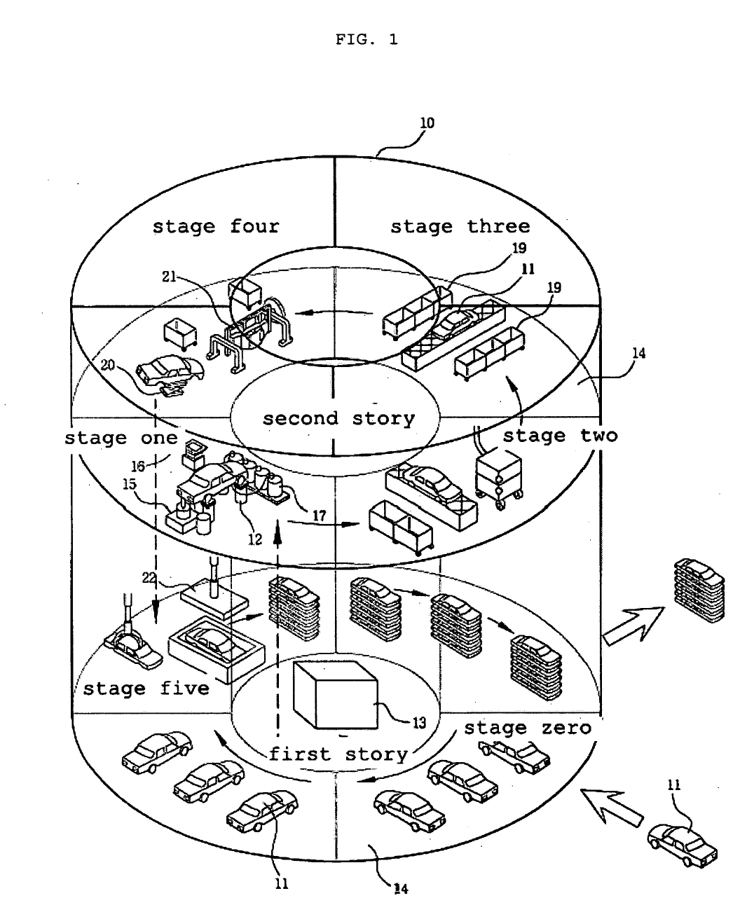

### DETAILED DESCRIPTION OF THE PREFERRED EMBODIMENTS

Reference will now be made in detail to the preferred embodiments of the present invention with reference to the attached drawing.

Embodiments of the present invention provide facilities arranged in a two-story circular building 10 such that the entire disassembling process of an end-of-life vehicle (ELV) from the vehicle's entering the building to the compression of the vehicle body is carried out around the circumference of the building.

As shown in the drawing, the facilities may be disposed in building 10 such that some stages of disassembly take place on the first floor and some on the second. In an exemplary embodiment, a vehicle's entering the building 10 (stage zero) takes place in the first story; recovery of liquid products (stage one), elimination of explosive components and recovery of re-usable components (stage two), recovery of interior/exterior components (stage three), and recovery of engine/discharge system/chassis components (stage four) take place in the second story; and crushing of the vehicle body (stage five) takes place in the first story. Facilities for stages 1-4 may be arranged sequentially around the circumference of the second story.

In the vehicle's entering the structure (stage zero), a vehicle 11 is identified and information such as its total weight, dimensions, etc. is recorded.

In the recovery of liquid products (stage one), the vehicle 11 is placed on a dedicated lifter 12 and liquid products such as fuel oil, engine oil, antifreeze, brake fluid, power steering fluid, transmission fluid, refrigerant, washer fluid, etc. are recovered.

In the elimination of explosive components (stage two), air bags, seat belt pretensioners, etc., are removed from the vehicle 11. Performing this stage before the rest of the disassembly process decreases the risk of equipment damage or injury.

In the recovery of re-usable components (stage two), components that are re-usable in other vehicles are recovered. These components include batteries, catalysts, tires, gas tanks, oil filters, etc.

In the recovery of interior/exterior components (stage three), components such as trims, covers, seats, etc., made of plastic material are recovered. In order to prevent pollution of interior components, the interior components are dismantled first and then exterior components, which may be contaminated with dust or other pollutants, are disassembled.

In the recovery of engine/discharge system/partial chassis components (stage four), the engine and partial chassis components are recovered. At this point, only the vehicle body, small parts (e.g., plastic material of less than 50 g, rubber parts, etc.), and impossible-to-reuse/recycle automotive components remain.

Lastly, after the remaining vehicle body and partial components have been crushed (stage five), ferrous and non-ferrous metal is separated from the crushed material to be recycled. Components that cannot be recycled, e.g., components formed of heterogeneous composite materials, plastic components, rubber components, etc., may be thermally treated and converted into gaseous or solid fuel, which can be used as a heat resource later. Otherwise, such components that cannot be recycled may be stored for reclamation purposes.

Vertical movement of the vehicle 11 between stories of the building 10 may be performed by a vehicle loading elevator 13, and the movement of the vehicle between stages in each story may be performed by a conveyor system 14 installed around each story of the building. In the case of a circular building 10, the vehicle loading elevator 13 is preferably installed near the center of the building 10, and the conveyor system 14 is preferably circular and concentric with the building 10.

Now, an exemplary method of disassembling ELVs will be described.

(1) A vehicle 11 enters the building 10 on the first story at stage zero. The vehicle's information such as its weight, dimensions, etc. is recorded. The vehicle 11 is lifted to the second story by the vehicle loading elevator 13.

(2) The vehicle 11 is moved by the conveyor system 14 to the liquid recovery facility. Whether or not a drain plug exists is identified for each liquid. In the winter, engine oil and/or transmission fluid may be coagulated within pans; these are pre-heated by pre-heater 14. The vehicle 11 is placed on a dedicated lifter 12 and a fuel oil recovery device 15 recovers the liquid products (stage one). The recovered liquid products are temporarily stored in intermediate storage vessels 17, and later transported to storage tanks outside the building.

(3) The vehicle 11 is moved by the conveyor system 14 to the explosive/re-usable component recovery facility. Air bags, seat belt pretensioners, etc. are removed (stage two). Re-usable components, such as batteries, catalysts, tires, gas tanks, oil filters, etc., are then recovered (stage two).

(4) The vehicle 11 is moved by the conveyor system 14 to the interior/exterior component recovery facility. Re-usable and recyclable components are recovered from the vehicle 11 (stage three). In such a recovery stage, more than two hundred to two hundred-fifty components such as trims, covers, seats, etc., made of plastic materials are recovered. In order to prevent pollution of interior components having a high possibility of re-use and direct recycling, the interior components are dismantled first and then exterior components, which may be contaminated with dust and other pollutants, are disassembled. The recovered plastic components are sorted by material and received in a movable receiving vessel 19, and then discharged to outside the building 10.

(5) The vehicle 11 is moved by the conveyor system 14 to the engine/discharge system/partial chassis component recovery facility. The engine is dismantled (20), then the discharge system and partial chassis components are dismantled (21). (stage four). Now only a vehicle body made of steel, small parts (plastic material of less than 50 g, rubber parts, etc.), and impossible-to-reuse/recycle automotive components remain.

(6) The vehicle 11 is moved by the vehicle loading elevator 13 to the crushing facility. Components that cannot be recycled, e.g., components formed of heterogeneous composite materials, plastic components of less than 50 g, rubber components, etc., are separated, crushed, thermally recovered, or stored for reclamation purpose. The vehicle body (ferrous and non-ferrous metal) and partial components are compressed by a vehicle body compressor 22 and discharged (stage five).

As apparent from the foregoing, according to the inventive ELV disassembling method and system, the entire disassembling process is automated to enable the minimum personnel to operate a disassembling facility while the vehicle moves step by step along the circumference of the building in each story, thereby shortening the time spent disassembling components and reducing the cost of disassembly per vehicle. Further, risk factors of accident are eliminated and storage tanks are provided to sufficiently deposit component parts generated during disassembly.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for disassembling end-of-life vehicles, said disassembling comprising a plurality of steps, said system comprising:
a building comprising a first story and a second story;
wherein each of said first and second stories comprises at least one facility, each facility corresponding to one of said steps.

2. The system as defined in claim 1, wherein a vehicle enters said building at said first story, and said first story facility comprises a first facility corresponding to a chronologically first one of said steps.

3. The system as defined in claim 1, wherein a vehicle body exits said building at said first story, and said first story facility comprises a last facility corresponding to a chronologically last one of said steps.

4. The system as defined in claim 1, wherein a vehicle enters said building at said first story, a vehicle body exits said building at said first story, and said first story facility comprises a first facility corresponding to a chronologically first one of said steps and a last facility corresponding to a chronologically last one of said steps.

5. The system as defined in claim 4, wherein said second story facility comprises an intermediate facility, corresponding to a chronologically intermediate one of said steps.

6. The system as defined in claim 4, wherein said second story facility comprises a plurality of intermediate facilities, each corresponding to a chronologically intermediate one of said steps, and said intermediate facilities are disposed sequentially in an order of said intermediate steps along a periphery of said second story.

7. The system as defined in claim 1, wherein said building is substantially cylindrical.

8. The system as defined in claim 6, wherein said building is substantially cylindrical and said intermediate facilities are disposed along a circumference of said second story.

9. The system as defined in claim 1, further comprising an elevator configured to move a vehicle between said first and second stories.

10. The system as defined in claim 1, further comprising a conveyor configured to move a vehicle within said second story.

11. The system as defined in claim 1, wherein said steps comprise:
recording a vehicle's information;
recovery of liquid products;
recovery of explosive components;
recovery of re-usable components;
recovery of interior/exterior components;
recovery of engine, discharge system, and partial chassis components; and
crushing of said vehicle.

12. The system as defined in claim 11, wherein said first story facility comprises a facility for said recording and a facility for said crushing, and said second story facility comprises a facility for said liquid recovery, a facility for said explosive recovery, a facility for said re-usable recovery, a facility for said interior/exterior recovery, and a facility for said engine/discharge system/partial chassis recovery.

13. A method of disassembling end-of-life vehicles comprising steps of recording a vehicle's information; recovering liquid products; recovering explosive components; recovering re-usable components; recovering interior/exterior components; recovering engine, discharge system, and partial chassis components; and crushing of said vehicle,
wherein at least one of said steps takes place on a first story of a building and at least another one of said steps takes place on a second story of said building.

14. The method as defined in claim 13, wherein said first story step comprises said recording and said crushing.

15. The method as defined in claim 14, wherein said second story step comprises said recovering liquid products; said recovering explosive components; said recovering re-usable components; said recovering interior/exterior components; and said recovering engine, discharge system, and partial chassis components.

16. The method as defined in claim 15, wherein said second story steps take place sequentially around a periphery of said second story.

17. The method as defined in claim 13, wherein said building is substantially cylindrical.

18. The method as defined in claim 16, wherein said building is substantially cylindrical and said second story steps take place sequentially around a circumference of said second story.

19. The method as defined in claim 13, wherein said building comprises an elevator which moves said vehicle between said first and second stories.

20. The method as defined in claim 13, wherein said building comprises a conveyor which moves said vehicle within said second story.
